(19) United States
(12) Patent Application Publication
(10) Pub. No.: US 2025/0091584 A1
(43) Pub. Date: Mar. 20, 2025

(54) CONTROL SYSTEM AND METHOD FOR VEHICLE SUSPENSION SYSTEM

(71) Applicant: CK MATERIALS LAB CO., LTD., Ansan-si, Gyeonggi-do (KR)

(72) Inventors: Hyeong Jun KIM, Ansan-si, Gyeonggi-do (KR); Young Chul CHA, Ansan-si, Gyeonggi-do (KR)

(21) Appl. No.: 18/686,450

(22) PCT Filed: Sep. 18, 2023
(86) PCT No.: PCT/KR2023/014036

§ 371 Date: Feb. 26, 2024

(30) Foreign Application Priority Data
Sep. 15, 2023 (KR) 10-2023-0123449

(51) Int. Cl. B60W 40/06; B60G 17/08

(52) U.S. Cl. CPC B60W 40/06; B60G 17/08; B60W 2420/403

(57) ABSTRACT

The present invention relates to a control system and method for a vehicle suspension system. More specifically, the present invention relates to a control system and method for a vehicle suspension system capable of controlling a suspension system of a traveling vehicle by detecting a road surface condition of a lane.

### TECHNICAL FIELD

The present invention relates to a control system and method for a vehicle suspension system. More specifically, the present invention relates to a control system and method for a vehicle suspension system capable of controlling a suspension system of a traveling vehicle by detecting a road surface condition of a lane.

### BACKGROUND ART

A vehicle suspension system is a device for connecting wheels to a vehicle body using multiple links and is configured to reduce vibration, impacts, or the like transmitted to the vehicle body depending on the condition of the road surface during travel of a vehicle, providing ride comfort to passengers.

In addition, the vehicle suspension system appropriately controls the shaking of the vehicle body to provide driving convenience while ensuring vehicle body stability and driving controllability even when the vehicle is running, turning, or braking.

In particular, recent electric vehicles' batteries or hydrogen vehicles' hydrogen tanks contain flammable, explosive inflammable materials, requiring more attention to prevent leakage of inflammable substances near high-voltage wiring in case of damage to the batteries or tanks. Although passive suspension systems, active suspension systems, and semi-active suspension systems have been proposed, these suspension systems respond simultaneously, immediately to vibrations, impacts, and the like transmitted to the vehicle body, so there are limitations in effectively reducing unforeseen vibrations or impacts, such as speed bumps and potholes, deviating from the average road surface condition.

Accordingly, there is a need for a vehicle suspension system that can detect road surface conditions in advance or continuously in real-time and flexibly respond to sudden changes in the road surface.

### DETAILED DESCRIPTION OF THE INVENTION

### Technical Problem

Accordingly, the present invention has been made to solve all the problems of the prior art as described above, and is directed to provide a control system and method for a vehicle suspension system capable of detecting a road surface condition in advance or in real-time to flexibly respond to sudden changes in the road surface and reduce vibrations or impacts transmitted to a vehicle body.

In addition, an object of the present invention is to provide a control system and method for a vehicle suspension system capable of controlling vibrations, impacts, etc., transmitted to a vehicle body according to a driving mode or road surface grade, to meet user needs.

Moreover, another object of the present invention is to provide a control system and method for a vehicle suspension system capable of minimizing impacts on the battery of an electric vehicle or a hydrogen tank of a hydrogen vehicle, thereby enhancing the durability and safety of the vehicle.

However, these objects are exemplary and the scope of the present invention is not limited thereto.

### Technical Solution

The above objects of the present invention are achieved by a control system for a vehicle suspension system, the control system configured to control a suspension system of a driving vehicle by detecting a road surface condition of a lane and comprising: a detection unit configured to detect a road surface condition of a lane, a storage unit configured to store road surface data regarding the road surface condition; a control unit configured to generate a damping control signal according to the road surface data; and a damper unit at least partially filled with a fluid containing magnetic particles, a current adjusted to the fluid being adjusted according to the damping control signal, wherein the road surface data is classified into a plurality of road surface grades according to a roughness value or a deviation of an elevation value of a road surface.

According to one embodiment of the present invention, the detection unit may include at least one of an image acquisition unit configured to image the road surface condition and acquire it or a sensing unit configured to quantify a driving state of a vehicle or the road surface condition.

According to one embodiment of the present invention, the control system may further include a navigation unit configured to provide guidance on a driving direction of a vehicle, wherein the road surface data may be pre-stored in the navigation unit or may be received and stored by the navigation unit from an external source.

According to one embodiment of the present invention, the damping control signal may include information on a current level applied to the damper unit corresponding to the road surface grade.

According to one embodiment of the present invention, as the road surface grade becomes higher, the current level applied to the damper unit may increase, and the absolute value of a damping adjustment amount of the damper unit may increase.

According to one embodiment of the present invention, when a road surface roughness value that differs by a set value or more from an average road surface roughness value of an arbitrary section of the lane is detected, the control unit may identify a section corresponding to the detected road surface roughness value as an obstacle section, set the road surface roughness value as obstacle data, and generate an obstacle control signal according to the obstacle data.

According to one embodiment of the present invention, the storage unit may store a road surface roughness value that differs by a set value or more from an average road surface roughness value of an arbitrary section of the lane as obstacle data, and the control unit may generate an obstacle control signal according to the obstacle data.

According to one embodiment of the present invention, when a vehicle travels again on a lane previously traveled, the road surface data and the obstacle data regrading a road surface condition of the relevant lane may be updated and stored.

According to one embodiment of the present invention, the road surface data may include the elevation value of the road surface, and the damping control signal may be a signal for controlling damping force of the damper unit to correspond to a change in slope of the altitude value of the road surface.

According to one embodiment of the present invention, the damper unit may include a cylinder housing; the fluid, containing the magnetic particles, filled in the cylinder housing; a piston part disposed in a longitudinal direction within the cylinder housing; and a coil part configured to apply a magnetic field to the fluid.

According to one embodiment of the present invention, the damping control signal may be a signal related to the strength of the magnetic field generated by the coil part, and as the strength of the magnetic field increases, a chain formed by the magnetic particles may strengthen, thereby increasing damping force of the damper unit.

According to one embodiment of the present invention, the damper unit may further include a dispersion part disposed on a region of the cylinder housing that is different from a region where the coil part is disposed and configured to apply a magnetic field to prevent precipitation of the magnetic particles in the fluid.

According to one embodiment of the present invention, the control system may further include a mode input unit configured to receive a driving mode of a vehicle, wherein the control unit may increase or decrease the classified road surface grades according to the driving mode.

According to one embodiment of the present invention, when the driving mode is changed from a normal mode to a sport mode, the control unit may generate the damping control signal by decreasing the classified road surface grades, and when the driving mode is changed from the normal mode to a comfort mode, the control unit may generate the damping control signal by increasing the classified road surface grades.

According to one embodiment of the present invention, a plurality of damper units respectively connected to a plurality of wheels may independently control damping force.

According to one embodiment of the present invention, the control system may further include a braking unit configured to decelerate a vehicle, wherein the control unit may generate a braking control signal to control the braking unit.

According to one embodiment of the present invention, when a vehicle enters the obstacle section, or a predetermined time before the vehicle enters the obstacle section, the vehicle may be decelerated by the braking control signal.

According to an embodiment of the present invention, the braking unit may include a brake housing; the fluid, containing the magnetic particles, filled in the brake housing; a rod unit disposed in a longitudinal direction within the brake housing; a brake plate unit extending in a direction perpendicular to the rod unit; and a brake coil part configured to apply a magnetic field to the fluid.

According to one embodiment of the present invention, the braking control signal may be a signal regarding the strength of the magnetic field generated by the brake coil part and as the strength of the magnetic field increases, a chain formed by the magnetic particles may strengthen, thereby increasing a braking force of the braking unit.

The above objects of the present invention are achieved by a control method of controlling a suspension system of a driving vehicle by detecting a road surface condition of a lane, the control method including the steps of (a) detecting a road surface condition of a lane; (b) generating road surface data regarding the road surface condition; and (c) generating a damping control signal according to the road surface data to adjust damping force of a vehicle damper unit at least partially filled with a fluid containing magnetic particles, wherein in step (b), the road surface data is classified into a plurality of road surface grades according to a roughness value or a deviation of an elevation value of a road surface, and in step (c), a current applied to the fluid is adjusted according to the damping control signal.

### Advantageous Effects

According to the present invention configured as described above, it is possible to flexibly respond to sudden changes in the road surface by detecting road surface conditions in advance or in real-time, thereby reducing vibrations, impacts, etc., transmitted to a vehicle body.

In addition, according to the present invention, it is possible to control vibrations, impacts, etc., transmitted to the vehicle body according to a driving mode or road surface grade, to meet user needs

Furthermore, according to the present invention, it is possible to minimize the impact on a battery of an electric vehicle or a hydrogen tank of a hydrogen vehicle, thereby enhancing the durability and safety of the vehicle.

However, the scope of the present invention is not limited by these effects.

### BRIEF DESCRIPTION OF DRAWINGS

FIG. 1 is a block diagram schematically illustrating the configuration of a control system for a vehicle suspension system according to one embodiment of the present invention.

FIGS. 2(a)-2(c) are diagrams schematically illustrating road surface conditions according to various embodiments of the present invention.

FIG. 3 is a block diagram schematically illustrating the configuration of a control system for a vehicle suspension system according to another embodiment of the present invention.

FIG. 4 is a diagram schematically illustrating a guidance screen of a navigation unit according to one embodiment of the present invention.

FIG. 5 is a diagram schematically illustrating a guidance screen of a navigation unit according to another embodiment of the present invention.

FIG. 6 is a diagram schematically illustrating an obstacle section on a road surface according to one embodiment of the present invention.

FIG. 7 is a diagram schematically illustrating a damper unit using a fluid containing magnetic particles according to one embodiment of the present invention.

FIGS. 8(a)-8(b) are diagrams illustrating a control process of a damper unit in an obstacle section according to one embodiment of the present invention.

FIG. 9 is a diagram schematically illustrating a damper unit using a fluid containing magnetic particles according to another embodiment of the present invention.

FIG. 10 is a block diagram schematically illustrating the configuration of a control system for a vehicle suspension system according to yet another embodiment of the present invention.

FIG. 11 is a diagram schematically illustrating a braking unit using a fluid containing magnetic particles according to one embodiment of the present invention.

FIGS. 12(a)-12(b) are diagrams illustrating an operation process of a control system for a vehicle suspension system according to one embodiment of the present invention.

FIG. 13 is a flowchart schematically illustrating a control method of a vehicle suspension system according to one embodiment of the present invention.

FIG. 14 is a flowchart schematically illustrating a method of controlling a vehicle suspension system when a vehicle passes an obstacle according to one embodiment of the present invention.

### REFERENCE NUMERALS

10: VEHICLE
20: LANE
21, 23, 25: ROAD SURFACE GRADE
26, 27: OBSTACLE
100, 200, 300: CONTROL SYSTEM FOR VEHICLE SUSPENSION SYSTEM
110, 210, 310: CONTROL UNIT
120, 220, 320: DETECTION UNIT
130, 235, 330: STORAGE UNIT
140, 240, 340: DAMPER UNIT
230: NAVIGATION UNIT
350: BRAKING UNIT

### MODE FOR INVENTION

In the following detailed description, reference is made to the accompanying drawings that show, by way of illustration, embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, similar reference numerals refer to the same or similar functions over various aspects, and the length, area, thickness, and the like and the form may be exaggerated for convenience.

Hereinafter, preferred embodiments of the present invention will be described in detail with reference to the accompanying drawings so that those skilled in the art may easily implement the present invention.

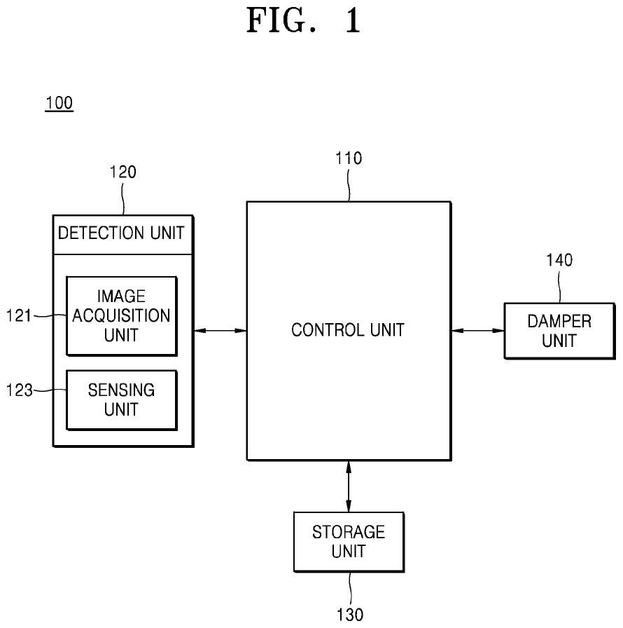

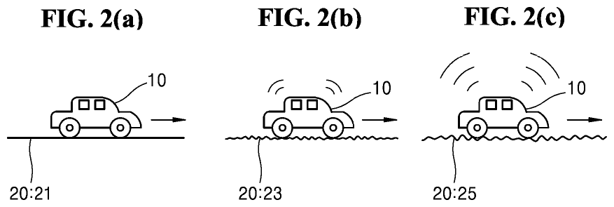

FIG. 1 is a block diagram schematically illustrating the configuration of a control system 100 for a vehicle suspension system according to one embodiment of the present invention. FIGS. 2(a)-2(c) are diagrams schematically illustrating road surface conditions according to various embodiments of the present invention.

Referring to FIG. 1, the control system 100 for a vehicle suspension system according to one embodiment of the present invention may include a control unit 110, a detection unit 120, a storage unit 130, and a damper unit 140.

The control unit 110 may receive data regarding road surface conditions from the detection unit 120 and the storage unit 130 to control the damper unit 140 and perform a series of functions controlling the flow of signals between each component. The control unit 110 is capable of communicating with the detection unit 120, the storage unit 130, and the damper unit 140, and the communication method may be configured regardless of the communication mode, including wired and wireless.

Referring to FIGS. 2(a)-2(c), the road surface condition of a lane 20 where the vehicle 10 is driving may be classified into a plurality of grades 21, 23, and 25. The road surface grades 21, 23, and 25 may be classified according to a roughness value or a deviation of an elevation value of the road surface. For example, FIG. 2(a) illustrates a road surface 21 of a well-maintained high-speed road with a low roughness value and a low deviation of an elevation value, resulting in minimal vibrations and impacts transmitted to the traveling vehicle 10. FIG. 2(b) illustrates a road surface 23 of a typical asphalt or cement road with a higher roughness value and a higher deviation of an elevation value compared to the road surface 21 of FIG. 2(a), resulting in moderate vibrations and impacts transmitted to the traveling vehicle 10. FIG. 2(c) illustrates a road surface 25 of an unpaved road (off-road) with gravel, sand, etc., exhibiting an even higher roughness value and a higher deviation of an elevation value compared to the road surface 23 of FIG. 2(b), resulting in the highest level of vibrations and impacts transmitted to the traveling vehicle 10. Although FIGS. 2(a)-2(c) classify the road surface conditions into three road surface grades 21, 23, and 25, it is also possible to more specifically subdivide the classification, such as designating highways as grade 1 and off-road as grade 10.

The road surface data may be understood as data that includes not only image data and numerical data including the road surface grades 21, 23, and 25 and roughness values and deviations of amplitude values for the road surface, but also sudden changes in road surface conditions (such as the presence of obstacles, rain, snow, or other sudden changes causing variations in the slipperiness of the road surface).

In particular, in the present invention, the control unit 110 may receive road surface data regarding the road surface condition from the detection unit 120 in real-time to control the damper unit 140, or it may control the damper unit 140 based on road surface data stored in the storage unit 130. A damping control signal for controlling the damper unit 140 may vary depending on the type of damper unit 140. For example, if the damper unit 140 is an active suspension, the damping control signal may include an electromagnetic frequency, a waveform, a pattern, etc. for operating an actuator of the active suspension, or a height control signal for adjusting the air pressure in an air spring. In another example, if the damper unit 140 is a semi-active suspension, the damping control signal may include an electromagnetic frequency, a waveform, a pattern, etc., for controlling the viscosity of a fluid such as a magnetorheological fluid or an electrorheological fluid. In the present invention, an example will be described in which the damper unit 140 is a semi-active suspension, filled with a fluid containing magnetic particles, and an applied magnetic field is controlled according to the damping control signal. A specific operation of the control unit 110 will be described further below.

The detection unit 120 may detect the road surface condition of the lane 20. The detection unit 120 may include at least one of an image acquisition unit 121 or a sensing unit 123.

The image acquisition unit 121 may use means such as cameras, radio detection and ranging (RADAR), light detection and ranging (LiDAR), and the like to image the road surface condition of the lane. The condition of the road surface, the position and shape of an obstacle, and the like may be directly captured as images through a camera or may be imaged through RADAR and LiDAR using radio waves and lasers. The road surface condition acquired by the image acquisition unit 121 may be input in real-time during travel of the vehicle.

The sensing unit 123 may use various sensors such as an accelerometer, an inertial measurement sensor, a gyro sensor, a distance measurement sensor, etc., to quantify the vehicle's driving state and road surface condition. Through the sensing unit 123, the vehicle's driving speed, degree of vibration, degree of inertia due to turning of the vehicle, and the like may be quantified, as well as the road surface condition, such as roughness of the road surface, variations in elevation of the road surface due to obstacles, average and deviation values thereof in an arbitrary section, distance and shape of obstacles, etc. may also be quantified. The vehicle's driving state and the road surface condition acquired by the sensing unit 123 can be input in real-time during travel of the vehicle.

The storage unit 130 may store road surface data regarding the road surface condition detected by the detection unit 120. The storage unit 130 may use various storage media such as HDD, SSD, flash memory, etc. that are placed within the vehicle and store data, as well as external servers, clouds, and the like that the vehicle can access in real-time to transmit and receive data.

The damper unit 140 is a means in which damping force is adjusted according to the damping control signal of the control unit 110. The damper unit 140 may use configurations such as active suspension, semi-active suspension, or the like. Considering the road surface data detected in real-time by the detection unit 120 and the road surface data stored in the storage unit 130, the control unit 110 may adjust the damping force of the damper unit 140 to optimize and reduce vibrations, impacts, etc., transmitted to the vehicle body according to the road surface condition. In one embodiment of the present invention, a damper unit 140 whose damping force is adjusted as a chain between magnetic particles in a fluid containing the magnetic particles strengthens, or a damper unit 140 whose damping force is adjusted according to the viscosity of a magnetorheological fluid (MRF) is taken as an example and described.

The control unit 110 may adjust a current level applied to the damper unit 140 according to the road surface grade. The current level may correspond to the intensity of the current applied to the damper unit 140, or the strength of the magnetic field generated by the current. The control unit 110 may control the absolute value of the damping force adjustment amount of the damper unit 140 to increase for a higher road surface grade. In other words, as the road surface becomes rougher, causing increased vehicle vibration, the damping force of the damper unit 140 may be controlled to be further increased. For example, in the case of a damper unit 140 using a fluid containing magnetic particles, the control unit 110 may set a higher current level to apply a stronger magnetic field to the fluid as the road surface grade becomes higher. The control unit 110 may generate a damping control signal including a high current level to increase the damping force.

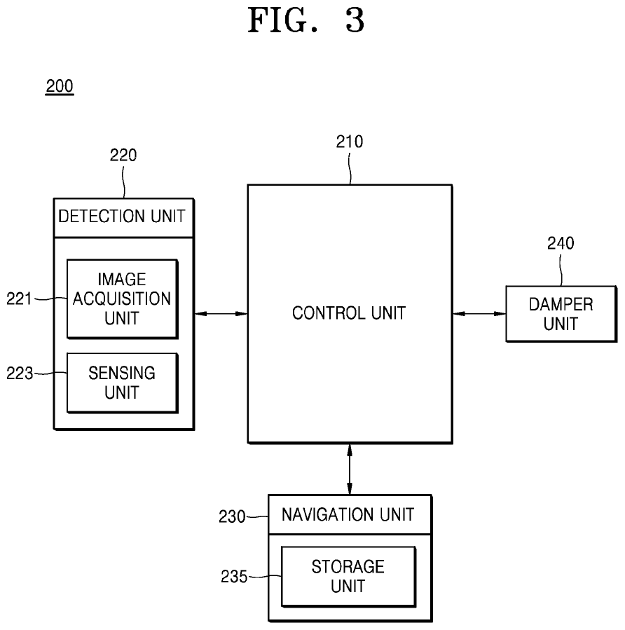

FIG. 3 is a block diagram schematically illustrating the configuration of a control system 200 for a vehicle suspension system according to another embodiment of the present invention.

Referring to FIG. 3, a control system 200 for a vehicle suspension system according to another embodiment of the present invention may include a control unit 210, a detection unit 220, a navigation unit 230, and a damper unit 240. Since the detection unit 220 and the damper unit 240 are the same as the detection unit 120 and the damper unit 140 in FIG. 1, detailed descriptions thereof are omitted.

The navigation unit 230 may provide a map around the vehicle and guidance on the direction of travel to the destination of the vehicle through a display. The navigation unit 230 may include a storage unit 235. The navigation unit 230 may pre-store not only maps for guiding the vehicle's route but also road surface data of the lane 20 in the storage unit 235. Alternatively, a communication unit (not shown) of the navigation unit 230 may receive road surface data from external sources and store it in the storage unit 235. In addition, the storage unit 235 of the navigation unit 230 may perform the same function as the storage unit 130 in FIG. 1, which can be used to store the road surface data regarding the road surface condition detected by the detection unit 220. Additionally, apart from the storage unit 235 of the navigation unit 230, the control system 200 for a vehicle suspension system itself may further include a separate storage unit.

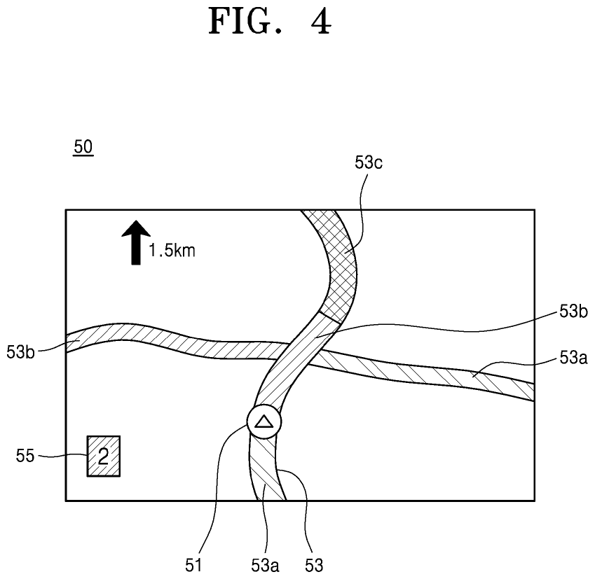

FIG. 4 is a diagram schematically illustrating a guidance screen 50 of a navigation unit 230 according to one embodiment of the present invention.

According to one embodiment of the present invention, lanes 53 are stored and displayed on a guidance screen 50 of the navigation unit 230 according to road surface grades 53a, 53b, and 53c. The guidance screen displays the current position and direction of the vehicle 51 through global positioning system (GPS), and the lanes 53 may indicate the road surface grades 53a, 53b, and 53c by distinguishing colors, patterns, shapes, etc. For example, road surface grade 53a may correspond to the high-speed road 21 as shown in FIG. 2(a), road surface grade 53b may correspond to the regular road 23 as shown in FIG. 2(b), and road surface grade 53c may correspond to the off-road 25 as shown in FIG. 2(c). Additionally, in order to improve the visibility of the vehicle driver, a grade window 55 may be provided to separately display the grade of the road on which the vehicle 51 is currently traveling.

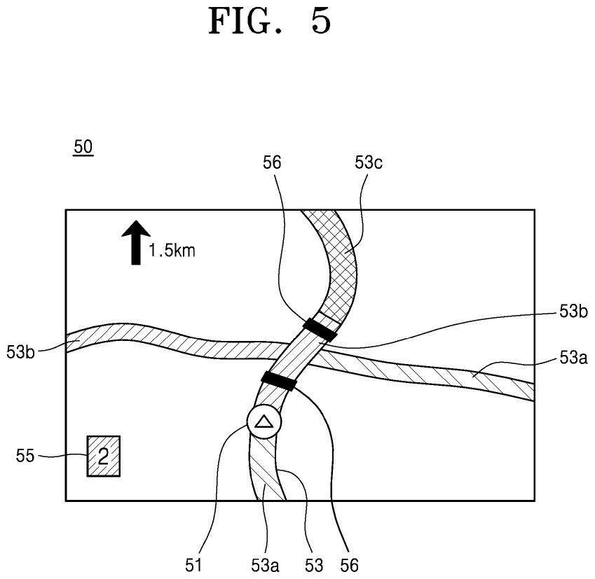

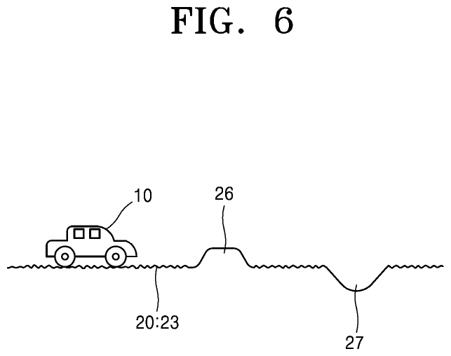

FIG. 5 is a diagram schematically illustrating a guidance screen 50 of a navigation unit 230 according to another embodiment of the present invention. FIG. 6 is a diagram schematically illustrating an obstacle section on a road surface according to one embodiment of the present invention.

According to one embodiment of the present invention, obstacle sections 56 on a lane 53 may be stored and displayed on the guidance screen 50 of the navigation unit 230. As shown in FIG. 6, obstacles may include a protruding obstacle 26 such as a speed bump, brick, tree, or the like that a vehicle 10 suddenly encounters while traveling on the lane 20, as well as a recessed obstacle 27 such as a pothole, sinkhole, or crack in the road. In other words, the obstacles 26 and 27 may refer to sections where the roughness value or elevation value differs by a set value or more from the roughness value or a deviation value of the elevation value of the road surface grade 23. The protruding obstacle 26 may indicate a section where the elevation value significantly increases in a positive direction, while the recessed obstacle 27 may indicate a section where the elevation value significantly increases in a negative direction. The obstacles 26 and 27 may occur intermittently or continuously on the lane 20.

The control unit 210 may identify a section where the road surface roughness value, or the deviation of an elevation value, corresponding to the obstacle 26 or 27 is detected as an obstacle section and set the relevant value as obstacle data. In addition, the control unit 210 may generate an obstacle control signal to adjust the damping force of the damper unit 240 according to the obstacle data. The control unit 210 may adapt the current level applied to the damper unit 240 according to the obstacle data. The obstacle control signal may include this current level. The damping control signal continuously adjusts the damper unit 240 according to the road surface condition while traveling on the lane 20, while the obstacle control signal adjusts the damper unit 240 when an obstacle is detected or its position is stored.

In cases where the obstacles 26 or 27 persistently exist on the lane 20, such as the protruding obstacle 26, such as a speed bump, and the recessed obstacle 27 occurring for a specific period of time due to construction, the navigation unit 230 may designate and display the locations of the obstacles 26 or 27 as obstacle sections 56 on the guidance screen 50. The navigation unit 230 may display the obstacle sections 56 by receiving road surface data from an external source via the communication unit (not shown) or by storing received road surface data in the storage unit 235.

Alternatively, without going through the process of storing the obstacle sections in the storage unit 235 of the navigation unit 230, the detection unit 220 may detect the obstacles 26 and 27, and immediately, the control unit 210 may generate obstacle control signals. The obstacles 26 and 27 may be detected in the form of an image by the image acquisition unit 221 of the detection unit 220, or if the sensing unit 223 detects a value that differs from the roughness value or the deviation of the elevation value corresponding to the road surface grade 23 by a set value or more, the detected value may be identified as the obstacle 26 or 27.

In particular, since data regarding the obstacles 26 and 27 can change over time, as the vehicle 10 travels along the lane 20, the obstacle data for the obstacles 26 and 27 may be updated. When the vehicle 10 travels again on the lane 20 previously traveled, the obstacle data for that lane 20 may be updated and stored in the storage unit 235. For example, when commuting on the same route, road surface data and obstacle data may be continuously updated, allowing for more detailed data storage and precise control of the damper unit 240, thereby providing passengers with a more comfortable ride on the familiar route. Additionally, an external server may collect road surface data and obstacle data from multiple vehicles and transmit them to the control system 200 for a vehicle suspension system of the present invention, so the road surface data and the obstacle data may be updated.

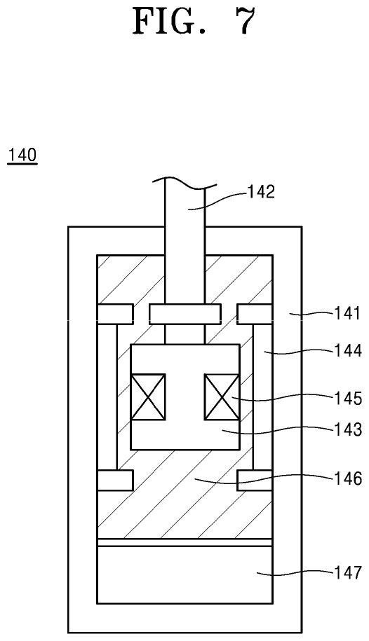

FIG. 7 is a diagram schematically illustrating a damper unit 140 using a fluid 146 containing magnetic particles according to one embodiment of the present invention.

According to one embodiment of the present invention, the damper unit 140 may adjust the damping force using a fluid 146 containing magnetic particles or a magnetorheological fluid 146. The purpose of the control system 100 for a vehicle suspension system according to the present invention is to control the suspension system by detecting the road surface condition of the lane more accurately in the autonomous driving mode or semi-autonomous driving mode of an electric vehicle or hydrogen vehicle. Therefore, there is an advantage in using the damper unit 140 capable of damping force control using electromagnetism.

Referring to FIG. 7, the damper unit 140 may include a cylinder housing 141, piston parts 142, 143, and 144, a coil part 145, and the fluid 146 containing magnetic particles (or the magnetorheological fluid 146).

The cylinder housing 141 has a sealed structure, and the sealed internal space may be filled with the fluid 146 containing magnetic particles. The cylinder housing 141 may be formed of a non-magnetic material to prevent interference with surrounding electronic components. Alternatively, at least a portion of the cylinder housing 141 may be formed of a non-magnetic material to prevent leakage of a magnetic field to the outside.

The piston parts 142, 143, and 144 may include a piston rod 142 extending in a longitudinal direction within the cylinder housing 141 and piston heads 143 and 144 provided at the ends of the piston rod 142. The piston rod 142 may move up and down due to external vibrations or impacts. The piston heads 143 and 144 may include an inner piston 143 and an outer piston 144. A passage or hole through which the fluid containing magnetic particles flows may be formed between the inner piston 143 and the outer piston 144. The fluids 146 containing magnetic particles may be placed in each space inside the cylinder housing 141. When the piston rod 142 moves up and down, the magnetorheological fluids 146 may flow through at least the gap between the piston heads 143 and 144.

Electromagnets may be provided in the piston parts 142, 143, and 144, and the coil part 145 may be disposed on the piston heads 143 and 144. The coil part 145 may generate a magnetic field when current is applied from the outside. The generated magnetic field may then be applied to the fluid 146 containing magnetic particles to adjust the viscosity of the fluid 146 containing magnetic particles.

A gas chamber 147 filled with a predetermined gas may be disposed at the lower part of the housing 141 and may be separated from the upper chamber filled with the fluid 146 containing magnetic particles.

However, the damper unit 140 is not necessarily limited to the above configuration, and various configurations are possible as long as their purpose is to adjust damping force by adjusting the viscosity of the fluid 146 containing magnetic particles (or the magnetorheological fluid 146).

When a magnetic field is applied to the fluid 146 containing magnetic particles, the magnetic particles within the fluid 146 form a chain structure in the horizontal direction perpendicular to the vertical direction of movement of the piston parts 142, 143, and 144, thereby resisting the movement of the piston parts 142, 143, and 144, and this resistance force may serve as a damping control means for the damper unit 140.

The damping control signal generated by the control unit 110 may be a signal related to the strength of the magnetic field generated by the coil part 145. The stronger the strength of the magnetic field, the stronger the chain formed by the magnetic particles in the fluid 146, resulting in an increase in damping force of the damper unit 140.

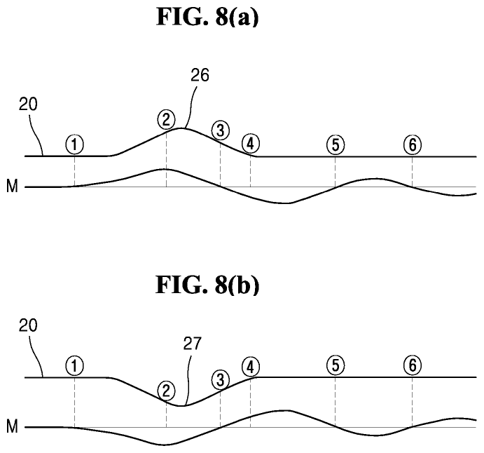

FIGS. 8(a)-8(b) is a diagram illustrating a control process of the damper unit 140 in an obstacle section according to one embodiment of the present invention.

Referring to FIG. 8(a), when passing over a protruding obstacle 26 such as a speed bump, the damper unit 140 may be controlled according to steps \textcircled{1} to \textcircled{6}.

\textcircled{1} The detection unit 120 may detect the protruding obstacle 26 and generate obstacle data, or retrieve obstacle data as data regarding the position of the protruding obstacle 26 from the storage unit 130. The control unit 110 may generate an obstacle control signal M. The obstacle control signal M may correspond to the strength of a magnetic field applied to the fluid 146 containing magnetic particles in the damper unit 140. When a magnetic field generated by the coil part 145 of the damper unit 140 is applied to the fluid 146 containing magnetic particles, chains of magnetic particles are formed, and as the viscosity of the fluid 146 containing magnetic particles increases, the damping force of the damper unit 140 may gradually increase. Control of the viscosity of the fluid 146 containing magnetic particles according to the obstacle control signal M may be performed at a speed of 500 Hz or higher.

\textcircled{2} Until just before reaching the top of the protruding obstacle 26, the control unit 110 may generate an obstacle control signal M of strong intensity, and the damping force of the damper unit 140 may increase.

\textcircled{3} At the moment of passing the peak of the protruding obstacle 26, the control unit 110 may reduce the intensity of the obstacle control signal M, and as the viscosity of the fluid 146 containing magnetic particles decreases, the damping force of the damper unit 140 may gradually decrease.

\textcircled{4} Until just before entering the horizontal plane after passing the peak of the protruding obstacle 26, the control unit 110 may generate an obstacle control signal M of strong intensity again, and the damping force of the damper unit 140 may increase. This is to increase the damping force of the damper unit 140 to prevent undulating bounce that occurs when the vehicle enters a horizontal road surface, passing the protruding obstacle 26.

\textcircled{5} When entering the horizontal plane after passing over the protruding obstacle 26, the control unit 110 may reduce the intensity of the obstacle control signal M, and as the viscosity of the fluid 146 containing magnetic particles decreases, the damping force of the damper unit 140 may gradually decrease.

\textcircled{6} When driving on the horizontal surface, the obstacle control signal M opposite to step \textcircled{5} may be applied to cancel out the vibration remaining in the vehicle.

Referring to FIG. 8(b), when passing over a recessed obstacle 27 such as a pothole, the damper unit 140 may be controlled according to steps \textcircled{1} to \textcircled{6}.

\textcircled{1} The detection unit 120 may detect the recessed obstacle 27 and generate obstacle data, or retrieve obstacle data as data regarding the position of the recessed obstacle 27 from the storage unit 130. The control unit 110 may generate an obstacle control signal M. When a magnetic field generated by the coil part 145 of the damper unit 140 is applied to the fluid 146 containing magnetic particles, the damping force of the damper unit 140 may gradually increase with the increase in viscosity of the fluid 146 containing magnetic particles.

\textcircled{2} Until just before reaching the bottom of the recessed obstacle 27, the control unit 110 may generate an obstacle control signal M of strong intensity, and the damping force of the damper unit 140 may increase.

\textcircled{3} At the moment of passing the bottom of the recessed obstacle 27, the control unit 110 may reduce the intensity of the obstacle control signal M, and as the viscosity of the fluid 146 containing magnetic particles decreases, the damping force of the damper unit 140 may gradually decrease.

\textcircled{4} Until just before entering the horizontal plane after passing the bottom of the recessed obstacle 27, the control unit 110 may generate an obstacle control signal M of strong intensity again, and the damping force of the damper unit 140 may increase. This is to increase the damping force of the damper unit 140 to prevent undulating bounce that occurs when the vehicle enters a horizontal road surface, passing the recessed obstacle 27.

\textcircled{5} When entering the horizontal plane after passing through the recessed obstacle 27, the control unit 110 may reduce the intensity of the obstacle control signal M, and as the viscosity of the fluid 146 containing magnetic particles decreases, the damping force of the damper unit 140 may gradually decrease.

\textcircled{6} When driving on the horizontal surface, the obstacle control signal M opposite to step \textcircled{5} may be applied to cancel out the vibration remaining in the vehicle.

With reference to FIG. 8(a), in steps \textcircled{1} to \textcircled{2}, the elevation value gradually increases. In other words, it is the section where the slope of the elevation value changes from 0 to positive. At this point, the absolute intensity of the obstacle control signal M increases, and the damping force of the damper unit 140 may also increase. In steps \textcircled{2} to \textcircled{3}, the elevation value increases and then decreases. In other words, it is the section where the slope of the elevation value changes from positive to negative. At this point, the absolute intensity of the obstacle control signal M decreases, and the damping force of the damper unit 140 may also decrease. In addition, in steps \textcircled{4} to \textcircled{5}, the elevation value decreases and then remains constant. In other words, it is the section where the slope of the elevation value changes from negative to 0. At this point, the absolute intensity of the obstacle control signal M increases again, and the damping force of the damper unit 140 may also increase. FIG. 8(b) also exhibits a similar behavior to that of FIG. 8(a), with the only distinction being the direction of intensity of the obstacle control signal M and the direction of the elevation value.

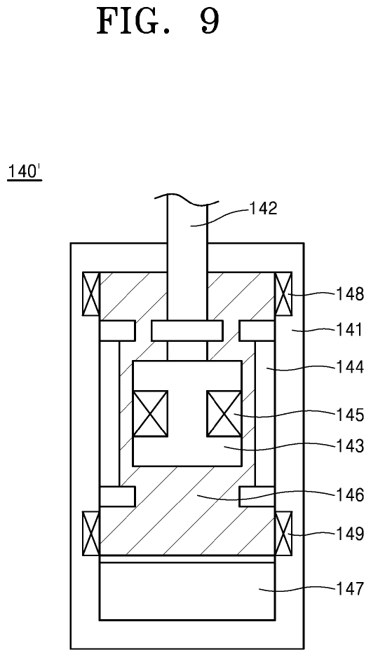

FIG. 9 is a diagram schematically illustrating a damper unit 140′ using a fluid 146 containing magnetic particles according to another embodiment of the present invention.

The damper unit 140 using a fluid 146 containing magnetic particles (or a magnetorheological fluid 146) may have a problem with precipitation of magnetic particles within the fluid. As time passes, the magnetic particles settle downward, which may prevent the proper formation of a magnetic chain within the cylinder housing 141 if the magnetic particles are not evenly dispersed. Particularly, after prolonged parking and resuming driving, the issue of the damper unit 140 not operating smoothly due to the precipitation of magnetic particles may arise. Therefore, to address the precipitation of magnetic particles, the damper unit 140′ of the present invention may further include dispersion parts 148 and 149.

The dispersion parts 148 and 149 may also consist of coils, similar to the coil part 145. The dispersion parts 148 and 149 are positioned in areas different from where the coil part 145 is placed and preferably may be distributed both in the upper and lower parts of the cylinder housing 141. Through the placement of dispersion parts 148 and 149, a magnetic field may be generated entirely within the cylinder housing 141. When the vehicle is started to resume driving, the dispersion parts 148 and 149, like the coil part 145, may apply a predetermined magnetic field to the fluid 146 containing magnetic particles. Accordingly, the magnetic particles may form a chain shape or an incomplete chain shape vertically or horizontally, and the repeated process of breaking up the shape may lead to the effect of redistribution.

Alternatively, the dispersion parts 148 and 149 may consist of permanent magnets. Even during parking, the dispersion parts 148 and 149 may retain the magnetic particles in a specific space of the fluid 146 containing magnetic particles. As a result, the magnetic particles are prevented from precipitating, and when driving is resumed, applying a magnetic field to the fluid 146 containing magnetic particles from the coil part 145 may lead to the redistribution of magnetic particles. The dispersion parts 148 and 149 may also be used in combination with both coil and permanent magnet configurations.

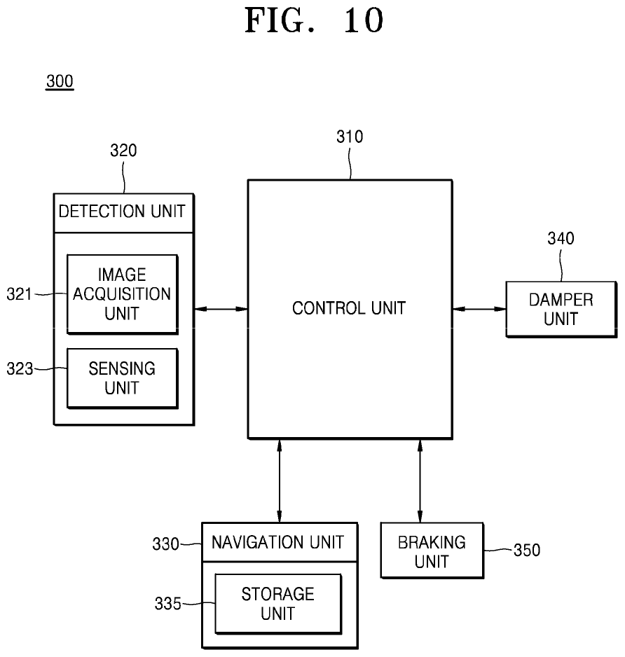

FIG. 10 is a block diagram schematically illustrating the configuration of a control system 300 for a vehicle suspension system according to yet another embodiment of the present invention.

Referring to FIG. 10, a control system 300 for a vehicle suspension system according to another embodiment of the present invention may include a control unit 310, a detection unit 320, a navigation unit 330, a damper unit 340, and a braking unit 350. Since the detection unit 220, the navigation unit 330, and the damper unit 240 are the same as the detection unit 220, the navigation unit 230, and the damper unit 240 in FIGS. 2(a)-2(c), detailed descriptions thereof are omitted.

The control system 300 for a vehicle suspension system of the present invention may further include the braking unit 350. The braking unit 350, in combination with the damper unit 350, may reduce vibrations and impacts transmitted to the vehicle 10 by controlling the speed of the vehicle 10. The control unit 310 may generate a braking control signal to control the braking unit 350.

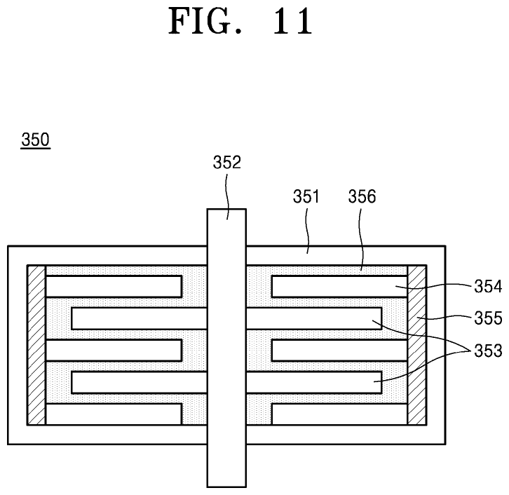

FIG. 11 is a diagram schematically illustrating the braking unit 350 using a fluid 356 containing magnetic particles according to one embodiment of the present invention.

According to one embodiment, the braking unit 350 may use a fluid 356 containing magnetic particles (or a magnetorheological fluid 356) and be connected to the wheels to control the braking force or speed of the vehicle. The purpose of the control system 300 for a vehicle suspension system according to the present invention is to control the suspension system by detecting the road surface condition of the lane more accurately in the autonomous driving mode or semi-autonomous driving mode of an electric vehicle or hydrogen vehicle. In autonomous driving mode or semi-autonomous driving mode, acceleration and deceleration must be performed as necessary according to road surface conditions. Therefore, there is an advantage in using the braking unit 350 capable of braking force control using electromagnetism.

Referring to FIG. 11, the braking unit 350 may include a brake housing 351, a rod unit 352, a brake plate unit 353, a brake coil part 355, and the fluid 356 containing magnetic particles (or magneticrheological fluid 356), and may further include a yoke portion 354.

The brake housing 351 may have a sealed structure, and the sealed internal space may be filled with the fluid 356 containing magnetic particles. The brake housing 351 may be formed of a non-magnetic material to prevent interference with surrounding electronic components. Alternatively, at least a portion of the brake housing 351 may be formed of a non-magnetic material to prevent leakage of a magnetic field to the outside.

The rod unit 352 may be rotatably installed at the center of the brake housing 351, and may extend in a vertical direction. The rod unit 351 may be connected to the wheel part, enabling direct and indirect braking of the wheel. One or more brake pad units 353 may be extended in a direction perpendicular to the rotor unit 352. The brake pad units 353 may be inserted onto the shaft of the rod unit 352 and rotate together with the rod unit 352, or they may be integrally formed with the rod unit 352.

The brake coil part 355 may be disposed inside the brake housing 351 and apply a magnetic field to the inside of the brake housing 351. The brake coil part 355 may generate a magnetic field when current is applied from the outside. The generated magnetic field may then be applied to the fluid 356 containing magnetic particles to adjust the viscosity of the fluid 356.

In addition, the fluid 356 containing magnetic particles forms a magnetic chain in the space between the brake plate parts 353, thereby resisting the rotation of the brake plate parts 353 in the axial direction of the rod unit 352. Accordingly, the braking force of the wheel connected to the rod unit 352 may be controlled.

Furthermore, the yoke unit 354 may be fixedly installed inside the brake housing 351. The yoke unit 354 may be positioned in the space between the brake pad units 353 and may have a shape including a surface facing the brake pad units 353. The gap between the horizontal planes of the brake pad unit 353 and the horizontal plane of the yoke unit 354 may be filled with the fluid 356 containing magnetic particles. Thus, changes in the viscosity, stiffness, and other properties of the fluid 356 containing magnetic particles may lead to changes in the rotation torque of the brake pad parts 353 and rod unit 352, allowing for control of the braking force of the wheel.

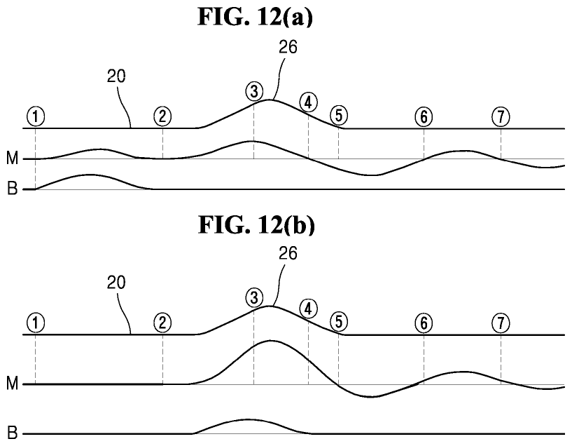

FIGS. 12(a)-12(b) are diagrams illustrating an operation process of the control system 300 for a vehicle suspension system according to one embodiment of the present invention.

Referring to FIG. 12(a), when passing over a protruding obstacle 26 such as a speed bump, the damper unit 340 and the braking unit 350 may be controlled according to steps \textcircled{1} to \textcircled{7}.

\textcircled{1} The detection unit 320 may detect the protruding obstacle 26 and generate obstacle data, or retrieve obstacle data as data regarding the position of the protruding obstacle 26 from the storage unit 330. However, before controlling only the damping force of the damper unit 340, the control unit 310 may generate a braking control signal B a predetermined time before entering the protruding obstacle 26. At this time, the braking control signal B may correspond to the strength of the magnetic field applied to the fluid 356 containing magnetic particles in the braking unit 350. When a magnetic field generated by the brake coil part 355 of the braking unit 350 is applied to the fluid 356 containing magnetic particles, chains of magnetic particles is formed, and as the viscosity of the fluid 356 containing magnetic particles increases, the braking force of the braking unit 350 may gradually increase.

As the braking force of the braking unit 350 increases and, in turn, the vehicle's speed decreases, the front of the vehicle is simultaneously subjected to vertical gravitational force. Consequently, it is preferable for the control unit 310 to generate a control signal M to increase the damping force of the damper unit 340 to prevent vibrations that occur as the vehicle rises after experiencing vertical gravitational force. Subsequently, the vehicle may enter step \textcircled{2} in a decelerated state.

Subsequent steps \textcircled{2} to \textcircled{7} substantially correspond to the control of the damper unit 140 in steps \textcircled{1} to \textcircled{6} described above in FIG. 8(a), and thus detailed descriptions thereof are omitted.

FIG. 12(b) represents a situation where a protruding obstacle 26 is detected more suddenly compared to FIG. 12(a), indicating a scenario where deceleration does not occur a predetermined time before entering the obstacle 26.

\textcircled{1} The vehicle is in a normal driving state where detection of the protruding obstacle 26 does not occur.

\textcircled{2} The detection unit 320 may detect the protruding obstacle 26 and generate obstacle data, or retrieve obstacle data as data regarding the position of the protruding obstacle 26 from the storage unit 330. The control unit 30 may generate an obstacle control signal M and a braking control signal B simultaneously. Here, the obstacle control signal M may correspond to the strength of a magnetic field applied to the fluid 345 containing magnetic particles in the damper unit 340, and the braking control signal B may correspond to the strength of the magnetic field applied to the fluid 356 containing magnetic particles in the braking unit 350. When magnetic fields generated by the coil part 344 of the damper unit 340 and the brake coil part 355 of the braking unit 350 are respectively applied to the fluids 345 and 356 containing magnetic particles, chains of magnetic particles are formed, and as the viscosity of the fluids 345 and 356 containing magnetic particles increases, the damping force of the damper unit 340 and the braking force of the braking unit 350 may gradually increase.

At this time, as the braking force of the braking unit 350 increases and, in turn, the vehicle's speed decreases, the front of the vehicle is simultaneously subjected to vertical gravitational force, causing the vehicle body to lower. Therefore, it is preferable for the control unit 310 to generate a damping control signal M to increase the damping force of the damper unit 340 to a greater extent than in step \textcircled{2} of FIG. 12(a), in order to prevent vibrations that occur as the vehicle rises after experiencing vertical gravitational force and to prevent vibrations that occur when the vehicle enters the protruding obstacles 26 and the position of the wheels rises. Ultimately, the vehicle may enter the protruding obstacle 26 while decelerating.

Subsequent steps \textcircled{3} to \textcircled{7} substantially correspond to the control of the damper unit 140 in steps \textcircled{2} to \textcircled{6} described above in FIG. 8(a), and thus detailed descriptions thereof are omitted.

Meanwhile, according to one embodiment of the present invention, the control systems 100, 200, or 300 for a vehicle suspension system may further include a mode input unit (not shown) to receive a driving mode of a vehicle from a driver. The driving mode may include a normal mode, a sport mode that allows for rougher and sportier driving than the normal mode, and a comfort mode that allows for more comfortable driving than the normal mode. The control units 110, 210, and 310 may increase or decrease the classified road surface grades 21, 23, and 25 (refer to FIGS. 2(a)-2(c)) according to the driving mode. In other words, the control units 110, 210, and 310 may readjust the road surface data values related to the road surface grades 21, 23, and 25.

For example, in the normal mode, the classified road surface grades 21, 23, and 25 and the road surface data may be used intact. When the driving mode changes from the normal mode to the sport mode, the control units 110, 210, and 310 may generate a damping control signal by decreasing the classified road surface grades 21, 23, and 25. In the sport mode, since less damping force control is required for the damper units 140, 240, and 340, a damping control signal corresponding to the high-speed road 21 is generated even on the regular road 23, and a damping control signal corresponding to the regular road 23 is generated even on the off-road 25, allowing the driver to experience a rougher and firmer driving feel. When the driving mode changes from the normal mode to the comfort mode, the control units 110, 210, and 310 may generate a damping control signal by increasing the classified road surface grades 21, 23, and 25. In the comfort mode, since more damping force control is required for the damper units 140, 240, and 340, a damping control signal corresponding to the high-speed road 21 is generated even on the regular road 23, and a damping control signal corresponding to the regular road 23 is generated even on the off-road 25, allowing the driver to experience a more comfortable and smoother driving feel.

Meanwhile, according to one embodiment of the present invention, a plurality of damper units 140, 240, and 340 respectively connected to a plurality of wheels may independently control damping force. Since the obstacles 26 and 27 do not come into contact with the plurality of wheels simultaneously, but only with a specific wheel. In such cases, damping force may be independently controlled for only the corresponding wheel. Alternatively, when the vehicle is turning, outer wheels receive stronger loads than inner wheels. Therefore, damping force may be independently controlled for the outer and inner wheels.

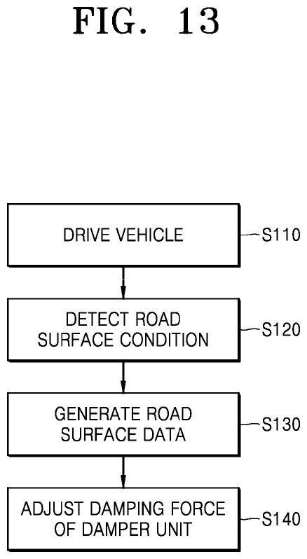

FIG. 13 is a flowchart schematically illustrating a control method of a vehicle suspension system according to one embodiment of the present invention.

First, a vehicle 10 may start driving (S110).

Next, the road surface condition on which the vehicle 10 is traveling may be detected (S120). Detection of the road surface condition may be performed in real-time through a detection unit 120. An image acquisition unit 121 may image the road surface condition, and a sensing unit 123 may quantify the driving state of the vehicle and the road surface condition.

Subsequently, road surface data may be generated based on the detected road surface condition (S130). The road surface condition detected by the detection unit 120 may be immediately converted into road surface data. The converted road surface data may be stored in a storage unit 130 or used directly to adjust the damping force of a damper unit 140. Alternatively, road surface data pre-stored in the storage unit 130 may be used.

Then, the damping force of the damper unit 140 may be adjusted based on the road surface data. The absolute value of the damping force adjustment amount of the damper unit 140 may be controlled to increase as the road surface grade becomes higher.

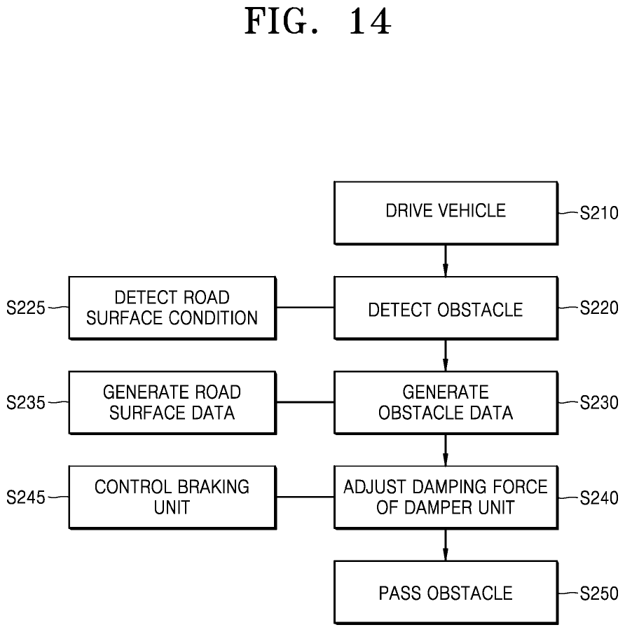

FIG. 14 is a flowchart schematically illustrating a method of controlling a vehicle suspension system when a vehicle passes an obstacle according to one embodiment of the present invention.

First, a vehicle 10 may start driving (S210).

Next, obstacles 26 and 27 on a road surface on which the vehicle 10 is traveling may be detected (S220). Detection of the obstacles 26 and 27 may be performed simultaneously with road surface condition detection (S225). Road surface condition detection (S225) corresponds to step S120 in FIG. 13. Sections where the roughness value or elevation value differs by a set value or more from the roughness value or a deviation value of the elevation value of the road surface grade may be detected as the obstacles 26 and 27. Alternatively, the obstacles 26 and 27 may also be detected in the image acquired by the image acquisition unit 121.

Subsequently, obstacle data may be generated (S230). Generation of the obstacle data may be performed simultaneously with road surface data generation (S235). Road surface data generation (S235) corresponds to step S130 in FIG. 13. The control unit 110 may generate an obstacle control signal to adjust the damping force of the damper unit 140 according to the obstacle data. In addition, a damping control signal may be generated according to the road surface data.

Then, based on the obstacle control signal and damping control signal, the damping force of the damper unit 140 may be adjusted. While adjusting the damping force of the damper unit 140, a braking unit 350 may be controlled (S245) to pass through the obstacles in a decelerated state.

In this way, the present invention has an effect of flexibly responding to sudden changes in the road surface by detecting road surface conditions in advance or in-real-time, thereby reducing vibrations, impacts, etc., transmitted to the vehicle body. In addition, it is possible to control vibrations, impacts, etc., transmitted to the vehicle body according to a driving mode or road surface grade, to meet user needs. As a result, the impact on a battery of an electric vehicle or a hydrogen tank of a hydrogen vehicle may be minimized, thereby enhancing the durability and safety of the vehicle.

Although the present invention has been shown and described with reference to a preferred embodiment as described above, the present invention is not limited to the above embodiment, and within the scope without departing from the spirit of the present invention, various modifications and changes can be made by those skilled in the art. It should be considered that such modification example and change example belong to the scopes of the present invention and the appended claims.

1. A control system for a vehicle suspension system, configured to control a suspension system of a driving vehicle by detecting a road surface condition of a lane and comprising:
a detection unit configured to detect a road surface condition of a lane;
a storage unit configured to store road surface data regarding the road surface condition;
a control unit configured to generate a damping control signal according to the road surface data; and
a damper unit at least partially filled with a fluid containing magnetic particles and configured to adjust a current applied to the fluid according to the damping control signal,
wherein the road surface data is classified into a plurality of road surface grades according to a roughness value or a deviation of an elevation value of a road surface.

2. The control system of claim 1, wherein the detection unit comprises at least one of an image acquisition unit configured to image the road surface condition and acquire it or a sensing unit configured to quantify a driving state of the vehicle or the road surface condition.

3. The control system of claim 1, further comprising:
a navigation unit configured to provide guidance on a driving direction of the vehicle,
wherein the road surface data is pre-stored in the navigation unit or is received and stored by the navigation unit from an external source.

4. The control system of claim 1, wherein the damping control signal comprises information on a current level applied to the damper unit corresponding to the road surface grade.

5. The control system of claim 4, wherein as the road surface grade becomes higher, the current level applied to the damper unit increases, and an absolute value of a damping adjustment amount of the damper unit increases.

6. The control system of claim 1, wherein when a road surface roughness value that differs by a set value or more from an average road surface roughness value of an arbitrary section of the lane is detected, the control unit is configured to identify a section corresponding to the detected road surface roughness value as an obstacle section, set the road surface roughness value as obstacle data, and generate an obstacle control signal according to the obstacle data.

7. The control system of claim 1, wherein the storage unit is configured to store a road surface roughness value that differs by a set value or more from an average road surface roughness value of an arbitrary section of the lane as obstacle data and the control unit is configured to generate an obstacle control signal according to the obstacle data.

8. The control system of claim 6, wherein when a vehicle travels on a lane previously traveled, the road surface data and the obstacle data regrading a road surface condition of the relevant lane is updated and stored.

9. The control system of claim 1, wherein the road surface data comprises the elevation value of the road surface and the damping control signal is a signal for controlling damping force of the damper unit to correspond to a change in slope of the elevation value of the road surface.

10. The control system of claim 1, wherein the damper unit comprises:
a cylinder housing;
the fluid, containing the magnetic particles, filled in the cylinder housing;
a piston part disposed in a longitudinal direction within the cylinder housing; and
a coil part configured to apply a magnetic field to the fluid.

11. The control system of claim 10, wherein the damping control signal is a signal related to a strength of the magnetic field generated by the coil part and as the strength of the magnetic field increases, a chain formed by the magnetic particles strengthens, thereby increasing damping force of the damper unit.

12. The control system of claim 10, wherein the damper unit further comprises a dispersion part disposed on a region of the cylinder housing that is different from a region where the coil part is disposed and configured to apply a magnetic field to prevent precipitation of the magnetic particles in the fluid.

13. The control system of claim 1, further comprising:
a mode input unit configured to receive a driving mode of the vehicle,
wherein the control unit is configured to increase or decrease the classified road surface grades according to the driving mode.

14. The control system of claim 13, wherein when the driving mode is changed from a normal mode to a sport mode, the control unit is configured to generate the damping control signal by decreasing the classified road surface grades and when the driving mode is changed from the normal mode to a comfort mode, the control unit is configured to generate the damping control signal by increasing the classified road surface grades.

15. The control system of claim 1, wherein a plurality of damper units respectively connected to a plurality of wheels may independently control damping force.

16. The control system of claim 6, further comprising:
a braking unit configured to decelerate a vehicle,
wherein the control unit is configured to generate a braking control signal to control the braking unit.

17. The control system of claim 16, wherein when the vehicle enters the obstacle section, or a predetermined time before the vehicle enters the obstacle section, the vehicle is decelerated by the braking control signal.

18. The control system of claim 16, wherein the braking unit comprises:
a brake housing;
the fluid, containing the magnetic particles, filled in the brake housing;
a rod part disposed in a longitudinal direction within the brake housing;
a brake plate part extending in a direction perpendicular to the rod unit; and
a brake coil part configured to apply a magnetic field to the fluid.

19. The control system of claim 18, wherein the braking control signal is a signal regarding a strength of the magnetic field generated by the brake coil part and as the strength of the magnetic field increases, a chain formed by the magnetic particles strengthens, thereby increasing a braking force of the braking unit.

20. A control method of controlling a suspension system of a driving vehicle by detecting a road surface condition of a lane, comprising the steps of:
(a) detecting a road surface condition of a lane;
(b) generating road surface data regarding the road surface condition; and
(c) generating a damping control signal based on the road surface data to adjust damping force of a vehicle damper unit at least partially filled with a fluid containing magnetic particles,
wherein in step (b), the road surface data is classified into a plurality of road surface grades according to a deviation of a roughness value or elevation value of a road surface and in step (c), a current applied to the fluid is adjusted according to the damping control signal.
